(19) United States
(12) Patent Application Publication
(10) Pub. No.: US 2024/0232718 A9
(43) Pub. Date: Jul. 11, 2024

(54) SYSTEM AND METHOD FOR LEARNING SPARSE FEATURES FOR SELF-SUPERVISED LEARNING WITH CONTRASTIVE DUAL GATING

(71) Applicants: Jae-sun Seo, Tempe, AZ (US); Jian Meng, Tempe, AZ (US); Li Yang, Tempe, AZ (US); Deliang Fan, Tempe, AZ (US)

(72) Inventors: Jae-sun Seo, Tempe, AZ (US); Jian Meng, Tempe, AZ (US); Li Yang, Tempe, AZ (US); Deliang Fan, Tempe, AZ (US)

(73) Assignee: Arizona Board of Regents on behalf of Arizona State University, Scottsdale, AZ (US)

(21) Appl. No.: 18/494,330

(22) Filed: Oct. 25, 2023

Related U.S. Application Data
(60) Provisional application No. 63/380,868, filed on Oct. 25, 2022.

(51) Int. Cl. G06N 20/00

(52) U.S. Cl. CPC G06N 20/00

(57) ABSTRACT

A method of training a machine learning algorithm comprises providing a set of input data, performing transforms on the input data to generate augmented data, to provide transformed base paths into machine learning algorithm encoders, segmenting the augmented data, calculating main base path outputs by applying a weighting to the segmented augmented data, calculating pruning masks from the input and augmented data to apply to the base paths of the machine learning algorithm encoders, the pruning masks having a binary value for each segment in the segmented augmented data, calculating sparse conditional path outputs by performing a computation on the segments of the segmented augmented data, and calculating a final output as a sum of the main base path outputs and the sparse conditional path outputs. A computer-implemented system for learning sparse features of a dataset is also disclosed.

### CROSS-REFERENCE TO RELATED APPLICATIONS

This application claims priority to U.S. Provisional Patent Application No. 63/380,868, filed on Oct. 25, 2022, incorporated herein by reference in its entirety.

### STATEMENT REGARDING FEDERALLY SPONSORED RESEARCH OR DEVELOPMENT

This invention was made with government support under 1652866 awarded by the National Science Foundation and under HR0011-18-3-0004 awarded by the Defense Advanced Research Projects Agency. The government has certain rights in the invention.

### BACKGROUND OF THE INVENTION

The success of the conventional supervised learning relies on the large-scale labeled dataset to minimize loss and achieve high accuracy. However, manually annotating millions of data samples is labor-intensive and time-consuming. This promotes self-supervised learning (SSL) to be an attractive solution, since artificial labels are used instead of human-annotated ones for training.

The state-of-the-art self-supervised learning frameworks, such as SimCLR (Chen et al., In International Conference on Machine Learning (ICML), pages 1597-1607, 2020) and MoCo (He et al., In IEEE/CVF Conference on Computer Vision and Pattern Recognition (CVPR), pages 9729-9738, 2020), utilize the concept of contrastive learning (CL) (Hadsell et al., In IEEE/CVF Conference on Computer Vision and Pattern Recognition (CVPR), volume 2, pages 1735-1742, 2006) with wide and deep models to achieve comparable performance as the supervised training counterpart. FIG. 1 shows the CIFAR-10 inference accuracy vs. the number of floating-point operations (FLOPs). By training from scratch, SimCLR (Chen et al., In International Conference on Machine Learning (ICML), pages 1597-1607, 2020) requires a model that is 4 times wider (ResNet-18 (4×)) to achieve similar accuracy as the baseline model trained with supervised learning (ResNet-18 (1×)). On the other hand, it is also difficult to achieve good accuracy with the compact model architecture (e.g., ResNet-20). The extraordinary computation cost necessitates efficient computation reduction techniques for self-supervised learning.

In the context of supervised learning, network sparsification has been widely studied. Both static weight pruning (Han et al., In Advances in Neural Information Processing Systems (NeurIPS), volume 28, 2015; Wei Wen et al., In Advances in Neural Information Processing Systems (NeurIPS), volume 29, pages 2074-2082, 2016) and dynamic computation skipping (Bejnordi et al., arXiv preprint arXiv:1907.06627, 2019; Gao et al., arXiv preprint arXiv:1810.05331, 2018; Hua et al., In Advances in Neural Information Processing Systems (NeurIPS), volume 32, 2019; Li et al., In IEEE/CVF International Conference on Computer Vision (CVPR), pages 5330-5339, 2021; Su et al., In European Conference on Computer Vision (ECCV), pages 138-155, 2020) have achieved high accuracy with pruned architectures or sparse features. A recent work (Chen et al., In IEEE/CVF Conference on Computer Vision and Pattern Recognition (CVPR), pages 16306-16316, 2021) reported the transferability of applying the lottery ticket hypothesis (Jonathan Frankle and Michael Carbin. arXiv preprint arXiv:1803.03635, 2018) to SSL for downstream tasks. However, the requirements of self-supervised pretraining and iterative searching greatly limit the practicality of the algorithm. Sparsifying SSL models that are trained from scratch is still largely unexplored, despite its importance.

To address this research gap, disclosed is a method for efficient dynamic sparse feature learning by training the model from scratch in a self-supervised fashion. Most of the prior works on dynamic computation reduction (Han et al., In Advances in Neural Information Processing Systems (NeurIPS), volume 28, 2015; Wei Wen et al., In Advances in Neural Information Processing Systems (NeurIPS), volume 29, pages 2074-2082, 2016) and dynamic computation skipping (Bejnordi et al., arXiv preprint arXiv:1907.06627, 2019; Gao et al., arXiv preprint arXiv:1810.05331, 2018; Li et al., In IEEE/CVF International Conference on Computer Vision (CVPR), pages 5330-5339, 2021; Su et al., In European Conference on Computer Vision (ECCV), pages 138-155, 2020) exploit spatial sparsity by using an auxiliary mini neural network (mini-NN) to determine feature salience. Besides the extra computation cost of mini-NN-based salience predictions, it was uncovered that it is problematic to use for contrastive learning due to significant accuracy degradation.

Products and services that perform self-supervised learning with constrained memory or computation could benefit from such methods. Thus, there is the need in the art for an efficient method for learning sparse features that is trained by self-supervised learning (SSL) using large unlabeled datasets that minimizes loss and achieves high accuracy in the dataset, while reducing the time and manual labor involved in training the system.

### SUMMARY OF THE INVENTION

In one aspect, a method of training a machine learning algorithm comprises providing a set of input data, performing first and second transforms on the input data to generate first and second augmented data, to provide first and second transformed base paths into first and second machine learning algorithm encoders, segmenting the first and second augmented data, calculating first and second main base path outputs by applying a weighting to the segmented first and second augmented data, calculating first and second pruning masks from the input and first and second augmented data to apply to the first and second base paths of the first and second machine learning algorithm encoders, the pruning masks having a binary value for each segment in the segmented first and second augmented data, respectively, calculating first and second sparse conditional path outputs by performing a computation on the segments of the segmented first and second augmented data which are designated with a binary one in the first and second pruning masks, respectively, and calculating a final output as a sum of the first and second main base path outputs and the first and second sparse conditional path outputs.

In one embodiment, the input data is a set of two-dimensional images. In one embodiment, the machine learning algorithm is an unlabeled, self-supervised machine learning algorithm. In one embodiment, the machine learning algorithm does not use a pre-trained dense model. In one embodiment, the second transform comprises an inverse diagonal transform. In one embodiment, the method further comprises eliminating irregular sparse indexes. In one embodiment, the method does not comprise introducing additional feature importance predictors. In one embodiment, the computation is a sparse computation. In one embodiment, the method further comprises applying a conditional weighting to the first and second conditional path outputs. In one embodiment, the first transform is different from the second transform. In one embodiment, the first and second transforms comprise color jittering.

In one aspect, a computer-implemented system for learning sparse features of a dataset comprises a plurality of input data elements, first and second transformation modules configured to perform first and second transforms on an input data element selected from the plurality of input data elements, having as an output first and second augmented data, first and second segmentation modules configured to segment each of the first and second augmented data into informative features and uninformative features, first and second base paths, configured to apply a base path weight to the uninformative features and provide as an output first and second weighted uninformative features, first and second masking modules, configured to generate first and second sparse pruning masks from the first and second weighted uninformative features, each sparse pruning mask having a binary value for each segment in the segmented first and second augmented data, respectively, a first convolution module configured to convolve the first sparse pruning mask, the first informative features, and a conditional weighting, and configured to provide as an output a first sparse feature output, a second convolution module configured to convolve the second sparse pruning mask, the second informative features, and the conditional weighting, and configured to provide as an output a second sparse feature output, and first and second output modules configured to add the first and second sparse feature outputs to the first and second uninformative features, configured to provide first and second final outputs.

In one embodiment, the plurality of input data elements are two-dimensional images. In one embodiment, the first transform is different from the second transform. In one embodiment, the first or second transform comprises an inverse diagonal transform. In one embodiment, the first or second transform comprises color jittering.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 displays the inference accuracy of various ResNet models with supervised and self-supervised training from scratch. After contrastive pre-training, models are fine-tuned on 50% of training set.

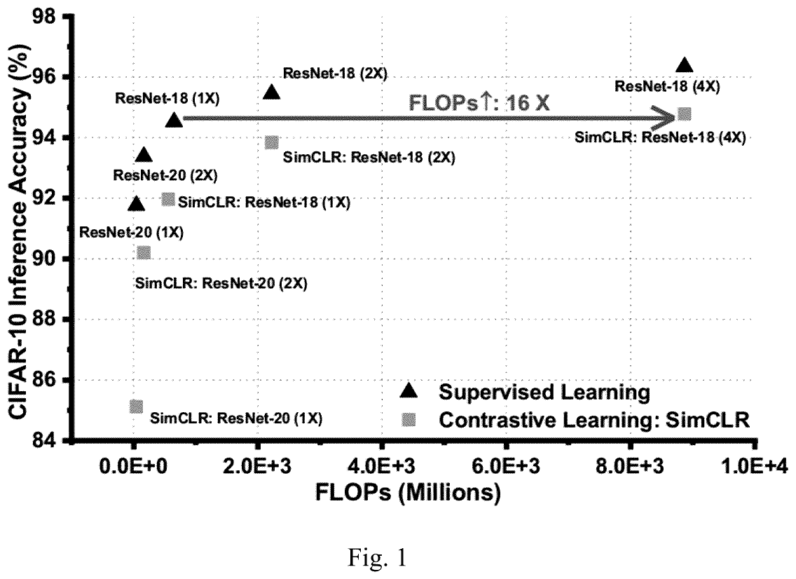

FIG. 2 is an overview of the proposed Contrastive Dual Gating (CDG) algorithm based on SimCLR framework, which learns sparse feature in both contrastive branches.

FIG. 3 displays the results for broadcasting the computed sparse masks M_{c}^{a}^{₁} to both contrastive paths and results in: (a) reduced contrastive training loss, and (b) defective generalizability with unsuccessful supervised linear evaluation.

FIG. 4 displays the shape-wise cosine similarity S, between the contrastive masks M_{c}^{a}^{₁} and M_{c}^{a}^{₂}. With identical base path W_{b} of ResNet-18, M_{c}^{a}^{₁} and M_{c}^{a}^{₂} become diverse from each other during training.

FIG. 5 depicts dual gating with different overlapping percentages based on four gating groups: (a) Unified dual gating with 100% overlap, (b) 75% overlap, (b) 50% overlap, and (d) 0% with disjoint base paths.

FIG. 6 depicts the granularity of structured CDG algorithm K1, K2 represents the two different groups with same size.

FIG. 7 displays the results for unstructured conditional path sparsity vs. CIFAR-10 inference accuracy of ResNet-18 with 4 gating groups.

FIG. 8 displays conditional path sparsity during (a) sparse contrastive training and (b) supervised fine-tuning based on CIFAR-10 dataset. (c) The layer-wise sparsity of ResNet-18 after fine-tuning.

FIG. 9 is a feature map visualization of base path and conditional path along two different contrastive branches.

FIG. 10 displays the results for unstructured conditional path sparsity vs. CIFAR-10 inference accuracy of ResNet-50 with 4 gating groups.

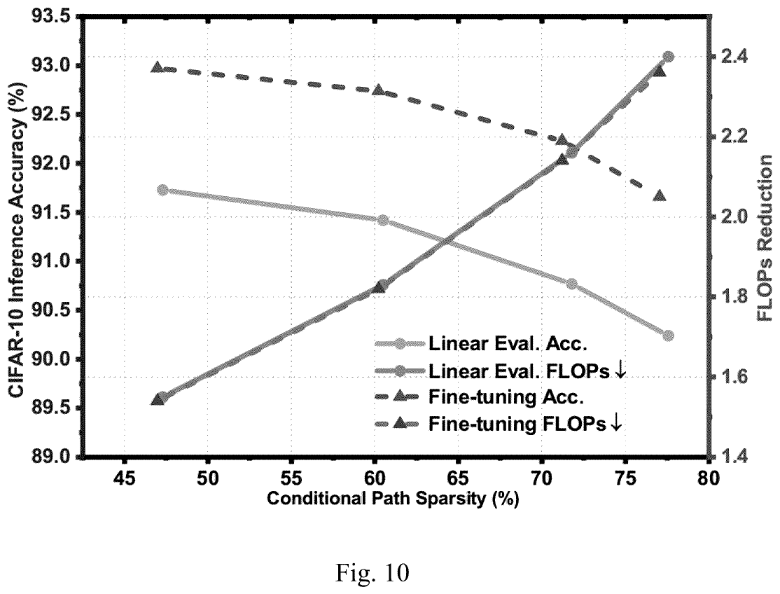

FIG. 11 displays the results for K-nearest neighbour (KNN) validation accuracy during Sim-Siam training with ResNet-18 on CIFAR-10 dataset.

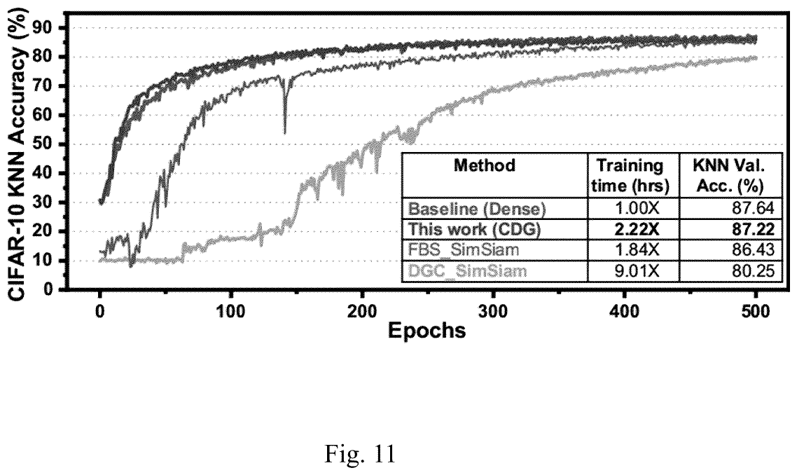

FIG. 12 is a computing device on which the disclosed system may operate according to aspects of the present invention.

FIG. 13 is pseudo-code for Algorithm 1 for the disclosed contrastive dual gating (CDG)

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### Learning Sparse Features for Self-Supervised Learning

Contrastive learning (or its variants) has recently become a promising direction in the self-supervised learning domain, achieving similar performance as supervised learning with minimum fine-tuning. Despite the labeling efficiency, wide and large networks are required to achieve high accuracy, which incurs a high amount of computation, which hinders the pragmatic merit of self-supervised learning. To effectively reduce the computation of insignificant features or channels, recent dynamic pruning algorithms for supervised learning employed auxiliary salience predictors. However, such salience predictors cannot be easily trained when they are naively applied to contrastive learning from scratch. To address this issue, disclosed herein is a method for contrastive dual gating (CDG), a novel dynamic pruning algorithm that skips the uninformative features during contrastive learning without hurting the trainability of networks. Demonstrated herein is the superiority of CDG with ResNet models for CIFAR-10, CIFAR-100, and ImageNet-100 datasets. Compared to implementations of state-of-the-art dynamic pruning algorithms for self-supervised learning, CDG achieves up to a 15% accuracy improvement for the CIFAR-10 dataset with higher computation reduction.

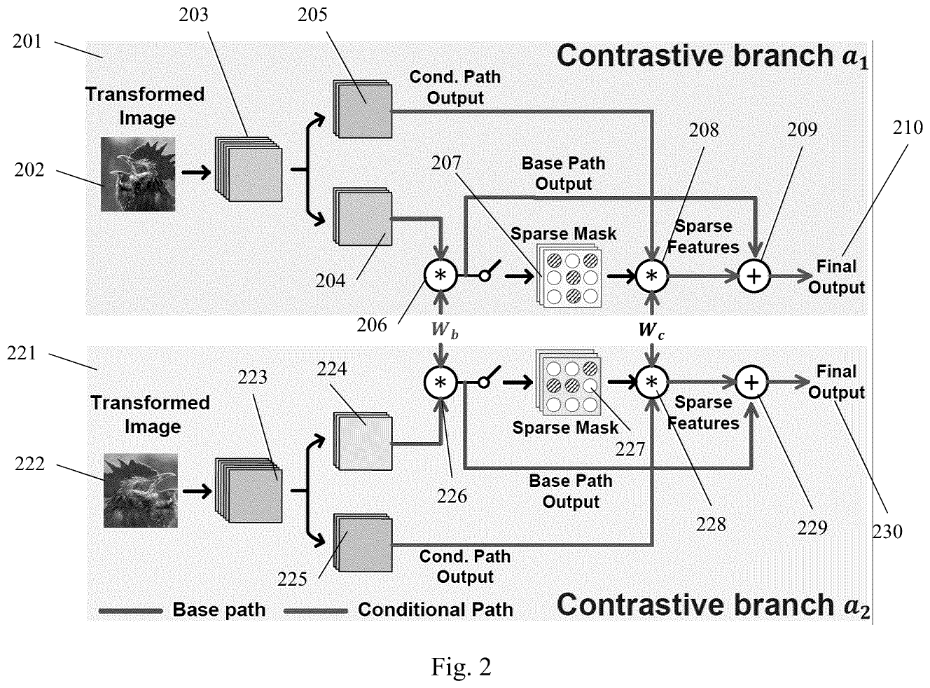

As opposed to mini-NN-based salience predictions, CDG exploits spatial redundancy by using a spatial gating function. Different from channel gating network (CGNet) (Hua et al., In Advances in Neural Information Processing Systems (NeurIPS), volume 32, 2019) presented for supervised learning, the proposed CDG algorithm for self-supervised learning exploits spatial redundancies with full awareness of the saliency difference between contrastive branches. As illustrated in FIG. 2, CDG learns the sparse features in both contrastive branches during the unsupervised learning process. Furthermore, CDG can exploit the sparse features in both structured and unstructured manners. Aided by efficient and optimized sparsification, CDG achieves high FLOPs reduction and high inference accuracy, without any auxiliary predictors.

Contrary to dynamic pruning for supervised learning where mini-NN-based saliency prediction improved the overall performance, it is shown herein that such auxiliary predictor schemes lead to inferior accuracy in dynamic pruning for self-supervised learning. The disclosed systems and methods are designed for contrastive self-supervised training with multiple recent contrastive learning frameworks. The disclosed systems and methods were applied to ResNet models across multiple datasets, and it was shown that CDG achieved up to 2.25× and 1.65×computation reduction for the CIFAR-10/-100 (Alex Krizhevsky, Geoffrey Hinton, et al. Learning multiple layers of features from tiny images. 2009) and ImageNet-100 datasets, respectively.

With reference to FIG. 2, a diagram of a disclosed Contrastive Dual Gating (CDG) system is shown. The system comprises two contrastive branches 201 and 221, each configured to accept input data, which in the present example comprises images 202 and 222, respectively. The images 202 and 222 may first have one or more image transforms applied prior to input into the contrastive branches. In some embodiments, one or both of image 222 and image 202 may undergo an inverse diagonal transform, a diagonal transform, a horizontal flip, a vertical flip, and/or color jittering. In some embodiments, images 202 and 222 may begin as the same image, but be different from one another after the transform(s) are applied. The images 202 and 222 are first segmented into a plurality of segments 203 and 223, respectively, and the segments are separated into uninformative features (204 and 224) and informative features (205 and 225). The informative features 204 and 224 are convolved with the base path weights W_{b} at 206 and 226, and then generate the feature masks at 207 and 227. The conditional path features 205 and 225 are convolved with the conditional path weighting K, at 208 and 228, where the computation skipping is guided by the sparse feature masks at 207 and 227. The base path and conditional path outputs are added back in at 209 and 229 to yield the final result 210 and 230.

### Learnable Salience Prediction

The inflation of model sizes produces different channel importance with changing inputs. Several recent works proposed to use an additional mini-NN to predict the uninformative features or channels. Given a high-dimensional input, a salience predictor generates a low-dimensional salience vector, which is used to formulate binary feature masks during supervised training.

Feature Boosting and Suppression (FBS) (Gao et al., arXiv preprint arXiv:1810.05331, 2018) estimates input channel importance by using an additional fully-connected (FC) layer followed by a Rectified Linear Unit (ReLU) activation function. Dynamic group convolution (DGC) (Su et al., In European Conference on Computer Vision (ECCV), pages 138-155, 2020) extends the design of FBS with more FC layers while deploying separate salience predictors in different output channel groups. Dynamic dual gating (DDG) (Li et al., In IEEE/CVF International Conference on Computer Vision (CVPR), pages 5330-5339, 2021) utilizes both convolution and fully connected layers to exploit spatial and channel feature sparsity.

The complex salience predictor improves the computation reduction but at the cost of deteriorating the trainability of the model. DDG (Li et al., In IEEE/CVF International Conference on Computer Vision (CVPR), pages 5330-5339, 2021) requires a pretrained static model for initialization, even for the CIFAR-10 (Alex Krizhevsky, Geoffrey Hinton, et al. Learning multiple layers of features from tiny images. 2009) dataset. None of the salience predictor designs have been studied for self-supervised learning.

### Channel Gating-Based Dynamic Pruning

Channel gating networks (CGNet) (Hua et al., In Advances in Neural Information Processing Systems (NeurIPS), volume 32, 2019) first executes a subset of input channels in every layer W_{b} (base path), the resultant partial sum is strategically gated to determine the remaining computation of the convolution layer W_{c} (conditional path). Strong correlations have been reported between base path outcomes and the final sum output, which means the uninformative features of the base path computation are also highly likely to be unimportant for the conditional path. The salience of the computation is evaluated based on the normalized base path output, where the features with large magnitude are deemed important and selected. Specifically, the base path output is formulated as:

Y_{base}=X_{base}*W_{b} Equation 1

In Equation 1, the “*” represents the convolution operation between the input X_{base} and the base path weights W_{b}. Subsequently, the computation decision M_{c}∈{0, 1} for the conditional path W_{c} can be computed as:

M_{c}=σₛ(normal(Y_{base})−τ) Equation 2

where τ represents the learnable gating threshold. For better gradient approximation, the non-linear function σₛ consists of a non-linear activation function and a unified step function. The features with small magnitude (less than the threshold) will be gated, and the binary decision mask M_{c} will be applied to the conditional path computation.

The final output of the convolution layer combines the dense base path and the sparse conditional path:

$${Y}_{i , j , k} = \{ \begin{matrix}{\{ {Y}_{b a s e} \}}_{i , j , k} & if {\{ {M}_{c} \}}_{i , j , k} = 0 \\ {\{ {Y}_{b a s e} \}}_{i , j , k} + {\{ {Y}_{cond} \}}_{i , j , k} & if {\{ {M}_{c} \}}_{i , j , k} = 1\end{matrix} \qquad Equation 3$$

As orthogonal to other methods that exploit structured channel sparsity, CGNet focuses on fine-grained sparsity along the spatial axes. However, employing the unstructured sparsity in hardware could be cumbersome due to the fine-grained sparse indexes. As a result, the structured feature sparsity should also be carefully investigated.

### Contrastive Self-Supervised Learning

In contrast to learning the representative features with the labeled data, contrastive learning (CL) trains the model based on the latent contrastiveness of high-dimensional features (Olivier Henaff. In International Conference on Machine Learning (ICML), pages 4182-4192, 2020; Geoffrey E Hinton, Neural Computation, 18(7):1527-1554, 2006). With a similarity-based contrastive loss function (van den Oord et al., arXiv preprint arXiv:1807.03748, 2018), CL maximizes the agreement between similar samples while repelling mismatched representations from each other. The success of the contrastive loss enables the state-of-the-art methods to optimize the model by using gradient-based learning. As a representative work, SimCLR (Chen et al., In International Conference on Machine Learning (ICML), pages 1597-1607, 2020) encodes two sets of augmented inputs (e.g., color jitter, Gaussian blur) with one single base encoder. Such end-to-end training frameworks exhibit less complexity but perform better with large models.

### Learning Sparse Features with Contrastive Training

Disclosed herein is an optimal dynamic gating strategy for self-supervised sparse feature learning. The strategy employs ResNet-18 architecture as the default base encoder of Sim-CLR (Chen et al., In International Conference on Machine Learning (ICML), pages 1597-1607, 2020) contrastive learning framework.

The pruning decision of CGNet (Hua et al., In Advances in Neural Information Processing Systems (NeurIPS), volume 32, 2019) is formulated by evaluating the feature salience of the base path outcome. With supervised learning, all intermediate features maps originate from the clean input image. However, in a contrastive supervised learning scheme, the inputs of the base encoder are the transformed images for different contrastive branches. For SimCLR (Chen et al., In International Conference on Machine Learning (ICML), pages 1597-1607, 2020), the two transformed inputs are generated by separate transformation operators from the same augmentation family T. Therefore, the question arises: Given a unique encoder network, will the base path feature salience be similar between the two augmented paths? In other words, can pruning decisions be transferred between two augmented features?

To answer the above questions, CGNet was used (Hua et al., In Advances in Neural Information Processing Systems (NeurIPS), volume 32, 2019) as the starting point with disabled channel shuffling to avoid the distortion of randomness. Given the two contrastive branches al and a₂, M_{c}^{a}^{₁} is first computed based on Equation 2 with the base path input X_{base}^{a}, then M_{c}^{a}^{₁} is broadcast to the conditional path of both contrastive branches:

Y_{cond}^{a}^{₁}&=X_{cond}^{a}^{₁}*W_{c}·M_{c}^{a}^{₁} Equation 4

Y_{cond}^{a}^{₂}&=X_{cond}^{a}^{₂}*W_{c}·M_{c}^{a}^{₁} Equation 5

where

M_{c}^{a}^{₁}=σₛ (normal (Y_{base}^{a}^{₁})−τ) Equation 6

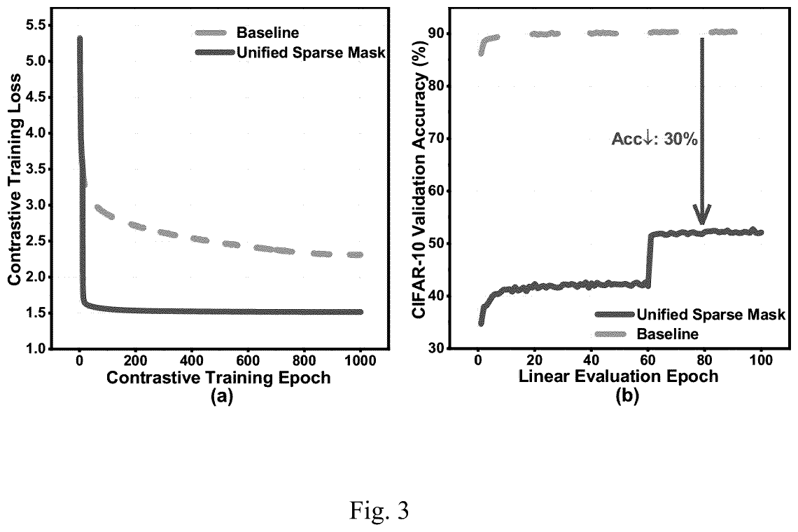

In some embodiments, the disclosed method comprises a step of training a ResNet-18 encoder from scratch on the CIFAR-10 dataset. Due to the low resolution (32×32), random Gaussian blur is excluded from the augmentation. Similar transformation methods have been verified in a previous implementation (Turrisi da Costa et al., arXiv preprint arXiv:2108.01775, 2021). As shown in FIG. 3(a), applying an identical dynamic pruning mask leads to a large reduction in contrastive loss from the baseline. However, the low contrastive pre-training loss cannot empower the subsequent supervised linear evaluation stage. The low accuracy shown in FIG. 3(b) implies that the feature extractor is defective due to unsuccessful contrastive learning.

With the absence of the geometric transformations, broadcasting dynamic sparse masks across different contrastive paths can be considered as revealing similar spatial features during the conditional path convolution. After convolving with the shared conditional path W_{c}, the projected low-dimensional vectors tend to have high similarities, leading to decreased contrastive loss.

Summarizing these empirical results: the unanimous data transformation operation T and the identical encoder f cannot guarantee feature salience to be similar across different augmented branches. This observation yields the following conclusion related to dynamic pruning: due to the distinct feature salience of contrastive learning, the pruning decision M_{c} is nontransferable between the contrastive branches (C1).

### Dual Gating for Contrastive Learning

Based on the conclusion above (C1), some embodiments of the systems and methods disclosed herein implement separate pruning decisions for both contrastive branches. Specifically, given the base path outputs Y_{base}^{a}^{₁}, Y_{base}^{a}^{₂}, dynamic sparse masks can be separately generated based on W_{b}:

M_{c}^{a}^{₁}&=σₛ (normal(X_{base}^{a}^{₁}*W_{b})−τ) Equation 7

M_{c}^{a}^{₂}&=σₛ (normal(X_{base}^{a}^{₂}*W_{b})−τ) Equation 8

With reference to FIG. 2 and Equation 7 above, a₁, and a₂ are contrastive branches that encode augmented input images, shown at 202 and 222, respectively. In addition, X_{base}^{a}^{₁}, X_{base}^{a}^{₂} are the base path input of contrastive path a₁, and a₂, respectively. With respect to Equation 7 and 8, “normal” is a normalization operation, and σₛ is a gating function to generate sparse masks shown as 207 and 227. Lastly, τ is the learnable gating threshold and M_{c}^{a}^{₁}and M_{c}^{a}^{₁} are the resultant conditional path sparsity predicted by the base path of contrastive paths a₁, and a₂, respectively.

Following the same training setup as in the section Learning Sparse Features with Contrastive Training, separate sparse masks are applied to both contrastive branches during training. During the subsequent linear evaluation, the method only applies M_{c}^{a}^{₁} to the frozen backbone model. As summarized in Table 1, the discriminative dual gating scheme improves both inference accuracy and conditional path sparsity by a significant margin. The previous conclusion confirms the necessity of applying distinct sparse masks to both contrastive branches whereas the salience difference between a₁ and a₂ requires a more quantitative investigation.

TABLE 1
Comparison of different gating schemes for CIFAR-10 accuracy
after contrastive pre-training and linear evaluation. Applying
the discriminative dual gating during the contrastive learning
significantly improves model performance.

| | Gating | Cond. Path | Inference |
|---|---|---|---|
| Methods | Groups | Spars. (%) | Acc. (%) |
| Baseline | — | — | 89.16 |
| Unified Gating | 4 | 52.29 | 52.53 |
| Dual Gating | 4 | 71.88 | 87.67 |

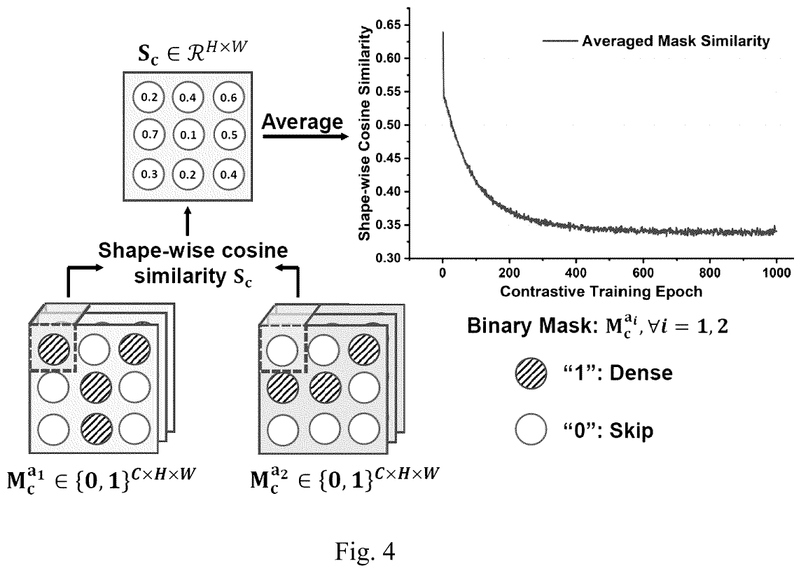

With regards to Table 1, “cond. path spars.” refers to the sparsity of the conditional path output, which is indicated by the sparse masks at 207 and 227 in FIG. 2. Now referring to FIG. 4, the average shapewise similarity S_{c} between M_{c}^{a}^{₁} and M_{c}^{a}^{₂} along the channel dimension C is displayed. Since the sparse masks are binary, the element-wise similarity can only be “0” or “1”. The global average mask similarity is computed by universally averaging the S_{c} of all the layers across all the training images of the CIFAR-10 dataset. FIG. 4 shows the averaged similarity between the contrastive feature masks M_{c}^{a}^{₁} and M_{c}^{a}^{₂} across the entire ResNet-18 model. At the start of training, the feature salience between the contrastive branches are similar S_{c}>0.6). As the sparsity increases during training, the similarity reduces to 0.34. The magnification of the dissimilarity during contrastive training leads to the following conclusion: Given unanimous data transformation (meaning that both contrastive paths have similar data augmentation methods), and identical base path selections W_{b}, contrastive training encourages the network f to highlight different contrastive features for better learning (C2).

### Unbiased Contrastive Grouping

To avoid biased weight updates, CGNet (Hua et al., In Advances in Neural Information Processing Systems (NeurIPS), volume 32, 2019) diagonally selects the base path across the evenly-divided input/output gating groups. In the previous description above, the disclosed method adopted the same computation strategy for contrastive learning. The conclusion C2 suggests that discriminative feature masks are beneficial for learning sparse features during contrastive training. The effectiveness of distinct spatial feature selection motivates the introduction of separate base paths for different contrastive branches during training. To that end, the present disclosure investigates the impact of the overlapped base paths and different computation partitions between the two contrastive branches.

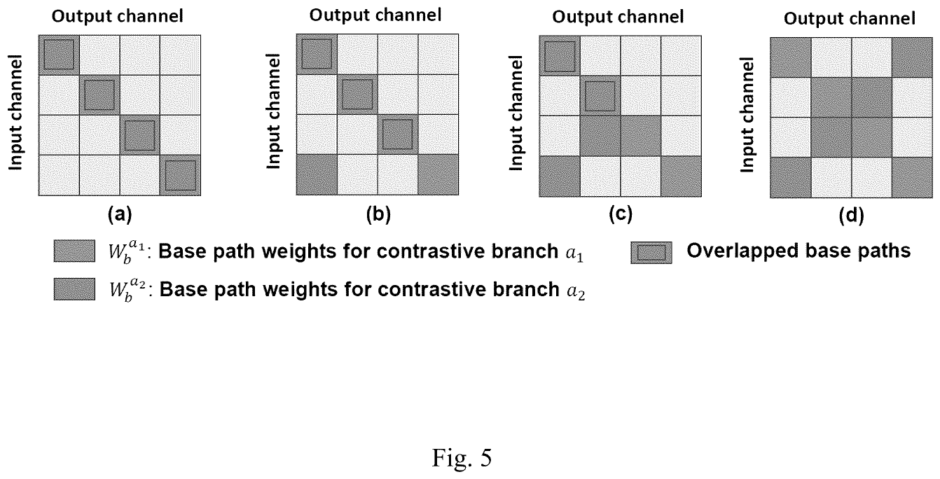

With four gating groups (G=4), FIG. 5 depicts the different intersection percentages of the separate base paths, where W_{b}^{a}^{_{1 and W}}_{b}^{a}^{₂} represents the base path weights of the two contrastive branches. The first step (a) involves setting W_{b}^{a}^{₁} along the diagonal, then varying the overlapping ratio with a different selection of W_{b}^{a}^{₂}. During the supervised linear evaluation, the method uses M_{b}^{a}^{₁} as the base path. Following the same contrastive training setup as section “Dual gating for contrastive learning,” the disclosed method trains the ResNet-18 model for CIFAR-10 with different levels of overlapping, then evaluates the inference accuracy after the supervised linear evaluation. Table 2 summarizes the model performance that is trained by different base path selections. Noticeably, the pre-trained model reaches the lowest inference accuracy when the contrastive base paths are overlapped by 50% with each other. As illustrated in FIG. 5, element (c), the first and second half of W_{b}^{a}^{₂} covers the same input channel groups while the remaining two output channel groups are ignored from the base path computation.

TABLE 2
Comparison of different overlapping ratio between the
contrastive base paths for CIFAR-10 accuracy after
contrastive pre-training and linear evaluation.

| | Gating | Cond. Path | Inference |
|---|---|---|---|
| Overlap | Groups | Sparsity (%) | Acc. (%) |
| Baseline | — | — | 89.16 |
| 100% | 4 | 71.88 | 87.67 |
| 75% | 4 | 71.02 | 87.59 |
| 50% | 4 | 70.60 | 87.12 |
| Disjoint (0%) | 4 | 72.48 | 88.59 |

Since the channel importance can be largely different, the inferior model performance with 50% channel overlapping signifies the importance of evenly distributing the computation to all the channel groups. Specifically, the repeated channels in the base path makes the learning process tend to update the corresponding weights more frequently, and the inactive weights in the remaining channels will eventually cause accuracy degradation. A similar discovery is also reported in (Hua et al., In Advances in Neural Information Processing Systems (NeurIPS), volume 32, 2019).

On the contrary, when W_{b}^{a}^{₁} and W_{b}^{a}^{₂} are completely disjointed, the contrastively trained model achieves the best inference accuracy with only 0.5% degradation from the dense baseline. By selecting W_{b}^{a}^{₁}, and W_{b}^{a}^{₂} along the disjoint diagonals, the base path computations are not subject to any biased training, where different features among different channels are activated to enhance contrastive learning. Based on these experiments and analysis, the following conclusion is derived: Given the base encoder f, evenly activating the disjoint channels among the different contrastive paths will enhance sparse feature learning during contrastive training (C3).

### Contrastive Dual Gating

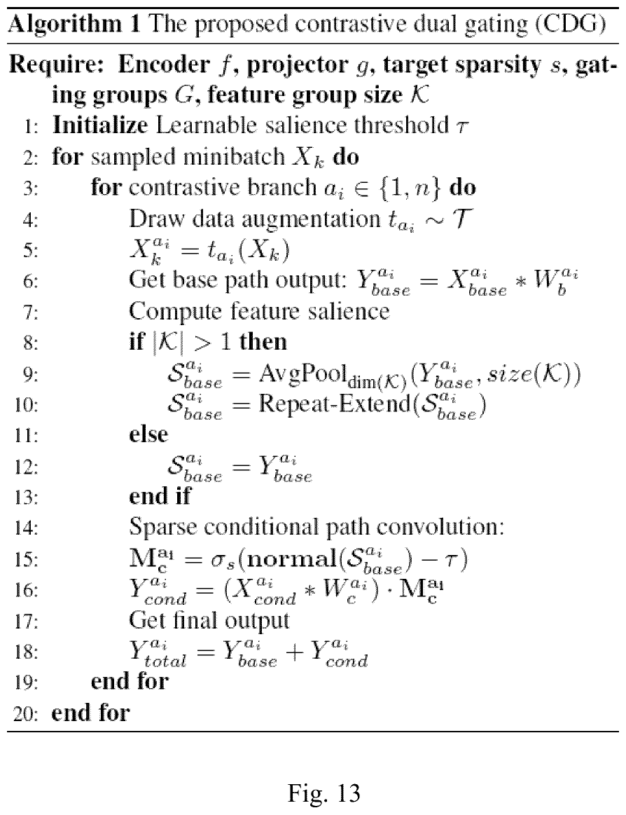

Based on the aforementioned analysis, disclosed is a Contrastive Dual Gating (CDG) algorithm for efficient dynamic sparse feature learning during contrastive self-supervised training. Pseudo-code illustrates the details of CDG in Algorithm 1 (as shown in FIG. 13). The present disclosure focuses in some embodiments on the Sim-CLR (Chen et al., In International Conference on Machine Learning (ICML), pages 1597-1607, 2020) framework with two contrastive branches, referred to as a₁ and a₂. During the forward pass of the contrastive training, CDG selects the contrastive base paths W_{b}^{a}^{₁} and W_{b}^{a}^{₂} along the diagonal and inverse-diagonal of the channel groups. The pruning masks M_{c}^{a}^{₁} and M_{c}¹^{₂} are generated separately based on the learnable salience thresholds τ∈R^{C}, along with the gating function:

M_{c}^{a}^{₁} &=σ_{d} (normal (X_{base}^{a}^{₁}*W_{b}^{a}^{₁})−τ Equation 9

M_{c}^{a}^{₂} &=σₛ (normal (X_{base}^{a}^{₂}*W_{b}^{a}^{₂})−τ Equation 10

With reference to FIG. 2 and Equations 9 and 10 above, a₁, and a₂ are contrastive branches that encode augmented input images, shown at 202 and 222, respectively. In addition, X_{base}^{a}^{₁}, X_{base}^{a}^{₂} are the base path input of contrastive path a₁, and a₂, respectively. With respect to Equation 9 and 10, “normal” is a normalization operation, and σₛ is a gating function to generate sparse masks shown as 207 and 227. Lastly, τ is the learnable gating threshold and M_{c}^{a}^{₁} and M_{c}^{a}^{₂} are the resultant conditional path sparsity predicted by the base path of contrastive paths a₁, and a₂, respectively.

The resultant element-wise binary sparse feature masks govern whether the corresponding 3×3 convolution of the conditional path computation is skipped or not. As illustrated in FIG. 5, the disjoint base paths of CDG allow the model to exploit the feature redundancy in a symmetric manner. The unbiased contrastive learning strategy satisfies the observation in the section labeled “Unbiased contrastive grouping.” After the forward pass computation, τ is optimized via the L₂ regularization based on the target sparsity value s:

$$L = {L}_{N T - Xent} + λ {\sum }_{i = 1}^{L} {‖ s - τ ‖}_{2} \qquad Equation 11$$

where L represents the number of layers of the encoder model, L_{NT-Xent} represents the contrastive loss of the SimCLR framework. s and τ are the regularization target and learnable gating parameter, and tunable parameterπ controls the penalty level of the regularization. During the backward pass, the method adopts a gradient smoothing technique (Hua et al., In Advances in Neural Information Processing Systems (NeurIPS), volume 32, 2019) to approximate the gradient of the non-differentiable gating function σₛ.

### Structured Contrastive Dual Gating

Compared to supervised training, the augmented contrastive inputs double the sparse indexes. Since both M_{c}^{a}^{₁} and M_{c}^{a}^{₂} have the same size as the output feature map, storing and processing such large fine-grained masks could introduce a large amount of memory and computation overhead in practice. Motivated by this, disclosed is a coarse-grained sparsity on top of the CDG algorithm. Specifically, given the base path output Y_{base}^{a}^{₁}, first computed is the average salience map Y_{base}^{a}^{₁} within each pre-defined group K:

S_{base}^{a}^{ᵢ}=AvgPool_{dlm}(K) (Y_{base}^{a}^{ᵢ}, size (K)) Equation 12

In Equation 12 above, Y_{base}^{a}^{ᵢ} is the convolution output resulted from the base path computation: Y_{base}^{a}^{ᵢ}=X_{base}^{a}^{ᵢ}*W_{b}^{a}^{ᵢ}. “AvgPool” represents the average pooling operation based on the pre-defined group size K. The S_{base}^{a}^{ᵢ} represents the structured features after pooling.

The size of K can be either 2-D or 3-D, depending on the practical needs of the computation. Since the average pooling operation will reduce the size of S_{base}^{a}^{ᵢ}, the disclosed method duplicates each averaged value by |K| times to avoid the dimensionality mismatch. Although Equation 12 above uses the AvgPool function for downsampling, it is understood that in other embodiments of the system, different downsampling methods may be used. Compared to the fine-grained CDG, introducing the structured pruning strategy simplifies the sparse indexes by |K| times, leading to reduced computation complexity and memory cost. The performance of the sparsified contrastive learning model is highly dependent on the group size selection. The larger pruning granularity leads to the compendious sparse convolution, meaning the simplified convolution operations are rewarded from the feature sparsity, whereas the unitary features will also magnify the accuracy degradation (Mao et al., In IEEE/CVF Conference on Computer Vision and Pattern Recognition (CVPR) Workshops, 2017). To balance the model performance and inference efficiency on targeted hardware, the disclosed method considers K as a tunable parameter and uses the unified group size |K| across the entire network.

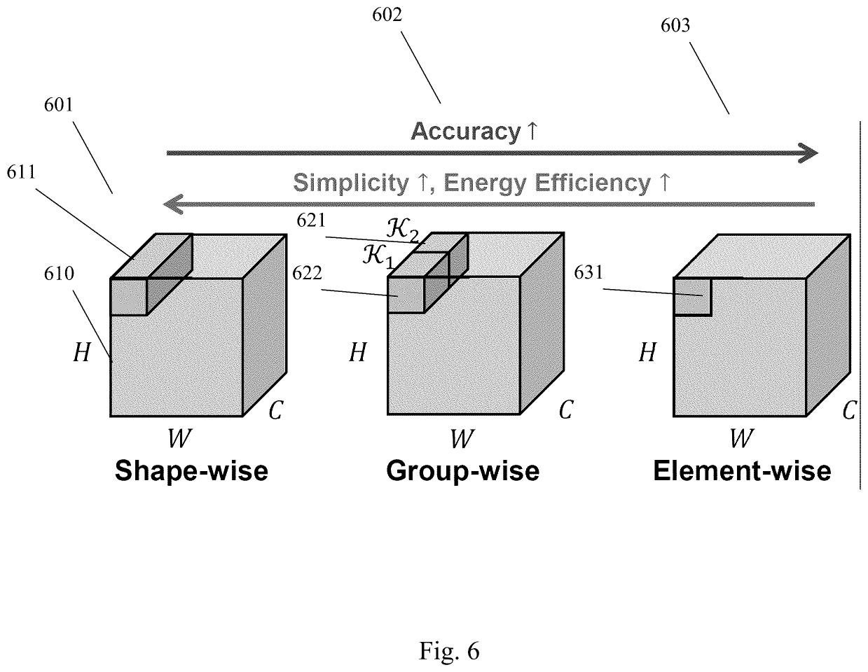

In particular, given the base path output Y_{base}∈R^{C×H×W}, the disclosed method sets the group size to K=C_{g}×1×1, where 1<C_{g}<C. FIG. 6 depicts the group configuration of CDG. With reference to FIG. 6, a diagram of different group sizes 601, 602, and 603 is shown. Each diagram includes a three dimensional representation of the image data 610 showing height (H), width (W), and channel (C). The shape-wise segmentation 601 includes a single grouping 611 for all channels in a given area. The group-wise segmentation 602 includes multiple groupings of channels (621, 622) for each given area. The element-wise segmentation 603 separates the data into individual elements 631 and performs no grouping. As shown in the diagram, element-wise segmentation 603 is the most accurate, but also the most computationally inefficient, while shape-wise segmentation 601 is the most efficient, but least accurate. Group-wise segmentation 602 therefore provides a more accurate, but less computationally intensive solution.

### Data Pipeline

In one embodiment, a data pipeline as disclosed herein, and as shown in FIG. 2, comprises input images of at least two contrastive branches being sent into a deep neural network. The input of each layer of the deep neural network is then separated into a base path and a conditional path along the channel dimension. The weight of the current layer is divided along the input channel, to match the channel size of the base and conditional path, forming “base path weights” and “conditional path weights.” The weights of each path are then convolved with the input of each path. The output of the base path is then sent through a gating function to generate a binary mask. The index of the 0 values in the binary mask generated from the base path then lead to the sparse computation on the conditional path. The final output is the sum of the dense base path output and the sparse conditional path output.

Considered as algorithmic steps, one overall data pipeline may comprise the steps of (1) Given the input of each layer as (N, C, H, W), m split into two chunks along the channel dimension. (2) Compute the base path with the corresponding base path weights (W_{b}). (3) Generate the sparse mask based on the base path output. (4) compute the conditional path with the corresponding weights (We). (5) Multiply the sparse mask with the conditional path output to formulate the sparse feature, and (6) Add the sparse conditional path output (sparse feature) to the base path output to calculate the final output.

### Computing Device

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

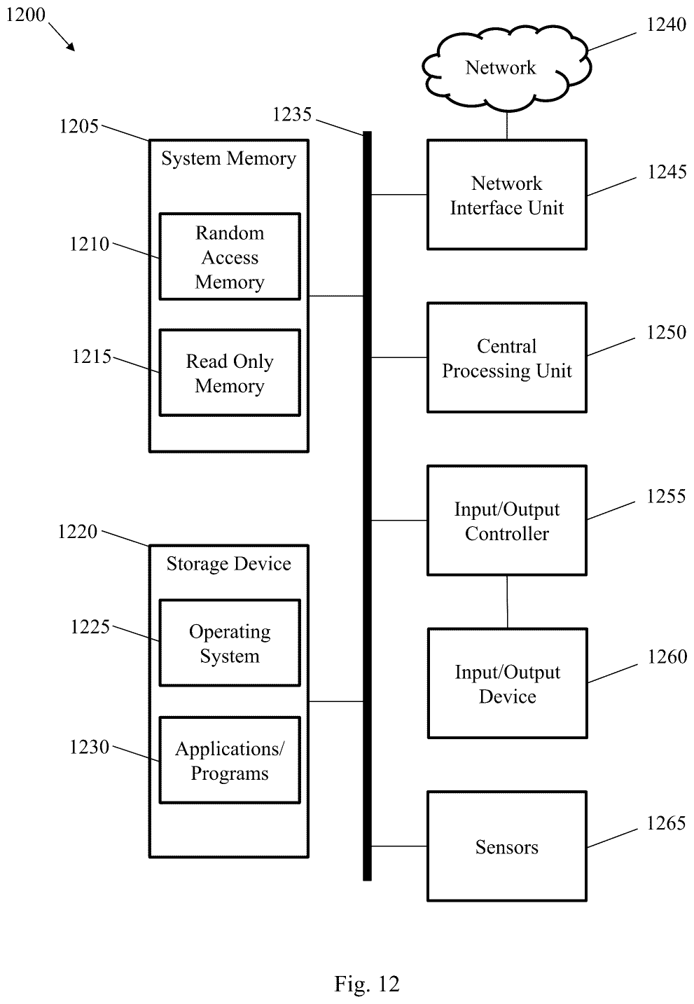

FIG. 12 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 12 depicts an illustrative computer architecture for a computer 1200 for practicing the various embodiments of the invention. The computer architecture shown in FIG. 12 illustrates a conventional personal computer, including a central processing unit 1250 (“CPU”), a system memory 1205, including a random access memory 1210 (“RAM”) and a read-only memory (“ROM”) 1215, and a system bus 1235 that couples the system memory 1205 to the CPU 1250. A basic input/output system containing the basic routines that help to transfer information between elements within the computer, such as during startup, is stored in the ROM 1215. The computer 1200 further includes a storage device 1220 for storing an operating system 1225, application/program 1230, and data.

The storage device 1220 is connected to the CPU 1250 through a storage controller (not shown) connected to the bus 1235. The storage device 1220 and its associated computer-readable media provide non-volatile storage for the computer 1200. Although the description of computer-readable media contained herein refers to a storage device, such as a hard disk or CD-ROM drive, it should be appreciated by those skilled in the art that computer-readable media can be any available media that can be accessed by the computer 1200.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 1200 may operate in a networked environment using logical connections to remote computers through a network 1240, such as TCP/IP network such as the Internet or an intranet. The computer 1200 may connect to the network 1240 through a network interface unit 1245 connected to the bus 1235. It should be appreciated that the network interface unit 1245 may also be utilized to connect to other types of networks and remote computer systems.

The computer 1200 may also include an input/output controller 1255 for receiving and processing input from a number of input/output devices 1260, including a keyboard, a mouse, a touchscreen, a camera, a microphone, a controller, a joystick, or other type of input device. Similarly, the input/output controller 1255 may provide output to a display screen, a printer, a speaker, or other type of output device. The computer 1200 can connect to the input/output device 1260 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 1220 and/or RAM 1210 of the computer 1200, including an operating system 1225 suitable for controlling the operation of a networked computer. The storage device 1220 and RAM 1210 may also store one or more applications/programs 1230. In particular, the storage device 1220 and RAM 1210 may store an application/program 1230 for providing a variety of functionalities to a user. For instance, the application/program 1230 may comprise many types of programs such as a word processing application, a spreadsheet application, a desktop publishing application, a database application, a gaming application, internet browsing application, electronic mail application, messaging application, and the like. According to an embodiment of the present invention, the application/program 1230 comprises a multiple functionality software application for providing word processing functionality, slide presentation functionality, spreadsheet functionality, database functionality and the like.

The computer 1200 in some embodiments can include a variety of sensors 1265 for monitoring the environment surrounding and the environment internal to the computer 1200. These sensors 1265 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

Disclosed are the experimental results of the proposed CDG algorithm for CIFAR-10, CIFAR-100, and ImageNet-100 datasets. The experiment used 50% labeled data for supervised finetuning. Similar to prior works (Turrisi da Costa et al., arXiv preprint arXiv:2108.01775, 2021), all experiments are conducted by training the SimCLR-ResNet-18 (Chen et al., In International Conference on Machine Learning (ICML), pages 1597-1607, 2020) model from scratch. Additional results with larger models (e.g., ResNet-50) are reported in further sections.

### The Impact of Gating Groups and Model Widths

The effectiveness of CDG is built upon the high correlation between the base path output and the final convolution results. Increasing the number of gating groups G reduces the amount of dense computation, whereas the insufficient base path partial sums will degrade the model performance.

The disclosed experiment evaluated model performance by changing the number of gating groups during the contrastive training. Given the number of gating groups G and conditional path sparsity η, the inference FLOPs reduction D_{FLOPS} is computed as:

$${D}_{FLOPs} = \frac{1}{\frac{1}{G} + ( 1 - η ) \times ( 1 - \frac{1}{G} )} \qquad Equation 13$$

Table 3 summarizes the CIFAR-10 accuracy and unstructured conditional path sparsity after post-training linear evaluation. With only 0.5% accuracy degradation, the proposed CDG algorithm achieves 2.19×FLOPs reduction by only using ¼dense convolution as the base path computation.

TABLE 3
Accuracy and FLOPs reduction of CDG with ResNet-18 (1×) on
CIFAR-10 dataset with different number of gating groups.

| # of | Conditional | Inference | Top-1 | |
|---|---|---|---|---|
| Gating | Path Sparsity | Accuracy | Accuracy | FLOPs |
| Groups | (%) | (%) | Drop | Reduction |
| 2 | 75.15 | 88.67 | −0.42 | 1.60× |
| 4 | 72.48 | 88.59 | −0.5 | 2.19× |
| 8 | 60.29 | 88.03 | −1.06 | 1.83× |

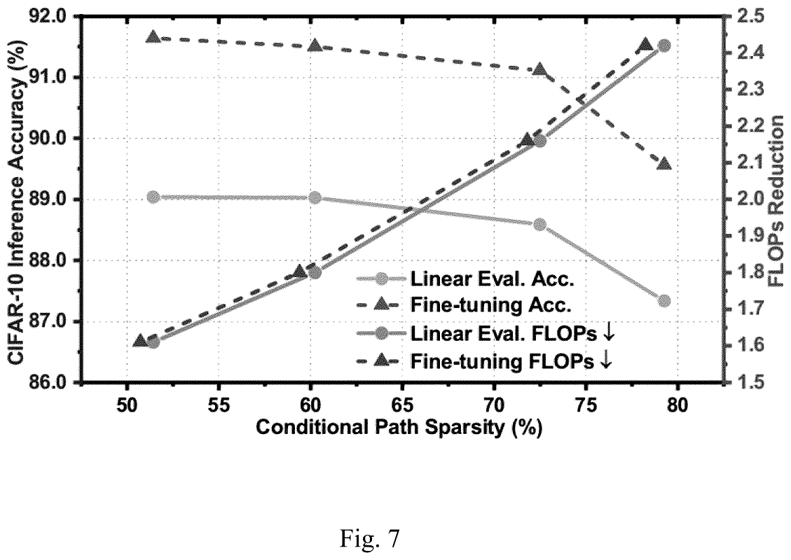

On the other hand, keeping 7/8 (G=8) of the convolution operation sparse has conservative computation reduction to maintain the accuracy. Therefore, the experiment below uses 4 gating groups. FIG. 7 illustrates the CIFAR-10 accuracy and computation reduction with different target s values and conditional path sparsity. The experiment also evaluated the proposed CDG algorithm based on ResNet-18 models with different widths. Table 4 summarizes the inference accuracy by training the model with the CIFAR-100 and ImageNet-100 datasets from scratch. The first and last layers of the ResNet-18 model are adjusted accordingly for different input image sizes. After the contrastive pre-training, the resulting sparse models are fine-tuned with a 50% labeled training set. Compared to the ResNet-18 baseline (1×) model, increasing the model width by 2x largely alleviates the accuracy degradation from the respective baseline model.

TABLE 4
Accuracy and FLOPs reduction of CDG on CIFAR-100 and ImageNet-100 datasets
with different ResNet-18 widths.

| | # of Gating | | Conditional Path | Inference | Top-1 Acc. | FLOPs |
|---|---|---|---|---|---|---|
| Model | Groups | Dataset | Sparsity (%) | Acc. (%) | Drop (%) | Reduction |
| ResNet- | 4 | CIFAR-100 | 70.1 | 66.04 | −1.74 | 2.11x |
| 18 (1x) | | ImageNet- | 50.05 | 76.82 | −2.05 | 1.60x |
| | | 100 | | | | |
| ResNet- | 4 | CIFAR-100 | 73.32 | 67.62 | −1.04 | 2.25x |
| 18 (2x) | | ImageNet- | 51.57 | 80.06 | −1.14 | 1.65x |
| | | 100 | | | | |

Following Algorithm 1 (as shown in FIG. 13), the experiment exploits the structured feature sparsity based on the designed sparse group selections. Table 5 reports the inference accuracy by exploiting the structured spatial-wise sparsity with group size of K=8×1×1.

TABLE 5
Structured contrastive dual gating for different datasets with the spatial group size K =
8 × 1 × 1. After the sparse contrastive pre-training, the model is fine-tuned on 50% of the
training labels.

| | # of | | Conditional | | Top-1 | | |
|---|---|---|---|---|---|---|---|
| | Gating | | Path Sparsity | Inference | Acc. | FLOPs | Index |
| Model | Groups | Dataset | (%) | Acc. (%) | Drop | Reduction | Reduction |
| ResNet- | 4 | CIFAR-10 | 71.64 | 90.37 | −0.89 | 2.16x | 8x |
| 18 (1x) | | CIFAR-100 | 66.24 | 65.94 | −1.84 | 1.98x | 8x |
| | | ImageNet- | 45.52 | 76.63 | −2.24 | 1.53x | 8x |
| | | 100 | | | | | |

Compared to unstructured pruning, the structured CDG algorithm achieves similar accuracy and computation reduction with 8×index reduction.

### Performance Comparison

As discussed above, the typical feature salience predictors can be fully-connected layers (Gao et al., arXiv preprint arXiv:1810.05331, 2018; Su et al., In European Conference on Computer Vision (ECCV), pages 138-155, 2020) or convolution layers (Li et al., In IEEE/CVF International Conference on Computer Vision (CVPR), pages 5330-5339, 2021; Gil Shomron et al., In EuropeanConference on Computer Vision (ECCV), pages 234-250, 2020). The increased complexity of the CNN-based salience prediction usually needs a pretrained model as the starting point (Li et al., In IEEE/CVF International Conference on Computer Vision (CVPR), pages 5330-5339, 2021), which is not suitable for all cases. Therefore, the analysis mainly aims to evaluate CDG with the methods that can train the models from scratch, e.g., FBS (Su et al., In European Conference on Computer Vision (ECCV), pages 138-155, 2020), DGC (Gao et al., arXiv preprint arXiv:1810.05331, 2018) and CGNet (Hua et al., In Advances in Neural Information Processing Systems (NeurIPS), volume 32, 2019). Note that these works only reported the performance with supervised training. To evaluate the performance of the prior works' methods for self-supervised learning, the experiment transferred the open-sourced dynamic pruning frameworks of (Gao et al., arXiv preprint arXiv:1810.05331, 2018; Hua et al., In Advances in Neural Information Processing Systems (NeurIPS), volume 32, 2019; Su et al., In European Conference on Computer Vision (ECCV), pages 138-155, 2020) and re-implemented them with the disclosed self-supervised learning setup. As part of the model architecture, the auxiliary salience predictors will be shared between the contrastive paths then get updated in an end-to-end manner.

The disclosed experiment evaluates the performance of the selected algorithms by training the ResNet-18 encoder on the CIFAR-10 dataset from scratch, using multiple SSL frameworks including SimCLR (Chen et al., In International Conference on Machine Learning (ICML), pages 1597-1607, 2020), MoCoV2 (Chen et al., arXiv preprint arXiv:2003.04297, 2020), and SimSiam (Chen et al. Exploring simple Siamese representation learning. In IEEE/CVF CVPR, 2021). For the algorithms with group-wise computation (Hua et al., In Advances in Neural Information Processing Systems (NeurIPS), volume 32, 2019; Su et al., In European Conference on Computer Vision (ECCV), pages 138-155, 2020), the experiment strictly follows the reported pruning strategy (e.g., sparsity schedule, number of output groups) during self-supervised training. The pre-trained sparse encoder will be fine-tuned under both supervised linear evaluation and fine-tuning process. This means that both linear evaluation and fine-tuning are supervised. The primary difference is linear evaluation freezes the training process of the pre-trained backbone model, and just individually trains the added linear layer with 100% of the table. On the other hand, fine-tuning process collectively trains both the backbone encoder and added linear layer with part of the total labels. In this disclosure, the linear evaluation is conducted with 100% labels to evaluate the ability of the feature extraction of the backbone. The fine-tuning process is used to further increase the accuracy with limited amount of labels. During the supervised fine-tuning phase, the experiment uses the target (final) sparsity value to avoid duplicate pruning.

The model performance of methods implemented are summarized in Table 6 (SimCLR (Chen et al., In International Conference on Machine Learning (ICML), pages 1597-1607, 2020) and Table 7 (Mo-CoV2 (Chen et al., arXiv preprint arXiv:2003.04297, 2020), and SimSiam (Chen et al. Exploring simple Siamese representation learning. In IEEE/CVF CVPR, 2021)). With different SSL training schemes, the proposed CDG algorithm outperforms all implementations of prior dynamic pruning methods in both inference accuracy and computation reduction. Specifically, the proposed CDG algorithm outperforms FBS (Su et al., In European Conference on Computer Vision (ECCV), pages 138-155, 2020) and DGC (Gao et al., arXiv preprint arXiv:1810.05331, 2018) by up to 15.7% (SimCLR), 2.3% (MoCoV2), and 7.8% (SimSiam) CIFAR-10 accuracy.

One important observation from the results in Table 6 and Table 7 is the opposite trend on the effectiveness of complex salience predictors between supervised vs. self-supervised learning. DGC (Su et al., In European Conference on Computer Vision (ECCV), pages 138-155, 2020) employed salience predictors for different output groups with 2×deeper mini-NNs than FBS (Gao et al., arXiv preprint arXiv:1810.05331, 2018), which improved the overall performance beyond FBS and CGNet (Gao et al., arXiv preprint arXiv:1810.05331, 2018; Hua et al., In Advances in Neural Information Processing Systems (NeurIPS), volume 32, 2019) for supervised training. For self-supervised training, however, such intricate salience predictors are difficult to train from scratch, resulting in degraded inference accuracy.

TABLE 6
With ResNet-18 (1×) for the CIFAR-10 dataset, CDG outperforms
FBS (Gao et al., arXiv preprint arXiv: 1810.05331, 2018),
DGC (Su et al., In European Conference on Computer Vision
(ECCV), pages 138-155, 2020), and CGNet (Hua et al., In Advances
in Neural Information Processing Systems (NeurIPS), volume
32, 2019) for SimCLR (Chen et al., In International Conference
on Machine Learning (ICML), pages 1597-1607, 2020) (referred
to as FBS SimCLR, DGC SimCLR, and CGNet SimCLR, respectively)
in both accuracy and FLOPs reduction.

| | # of | Linear Eval. | Fine-tuning | |
|---|---|---|---|---|
| | Gating | Inference | Inference | FLOPs |
| Method | Groups | Accuracy (%) | Accuracy (%) | Reduction |
| This work | 4 | 88.84 | 90.74 | 2.12× |
| (CDG_SimCLR) | | | | |
| FBS_SimCLR | — | 86.91 | 88.89 | 2.00× |
| DGC_SimCLR | 4 | 73.1 | 81.77 | 2.11× |
| CGNet_SimCLR | 4 | 87.4 | 89.26 | 2.09× |

TABLE 7
With ResNet-18 (1×) for the CIFAR-10 dataset, CDG outperforms
FBS (Su et al., In European Conference on Computer Vision (ECCV),
pages 138-155, 2020), DGC (Gao et al., arXiv preprint arXiv:
1810.05331, 2018), and CGNet (Hua et al., In Advances in Neural
Information Processing Systems (NeurIPS), volume 32, 2019) with
the MoCoV2 (Chen et al., arXiv preprint arXiv: 2003.04297, 2020)
and SimSiam (Chen et al. Exploring simple Siamese representation
learning. In IEEE/CVF CVPR, 2021) SSL frameworks.

| | # of | Linear Eval. | Top-1 | |
|---|---|---|---|---|
| | Gating | Inference | Acc. Drop | FLOPs |
| Method | Groups | Acc. | (%) | Reduction |
| This work | 4 | 90.58% | −0.86 | 2.00× |
| (CDG_MoCo) | | | | |
| FBS_MoCo | — | 88.29% | −3.15 | 2.00× |
| DGC_MoCo | 4 | 85.42% | −4.2 | 2.11× |
| CGNet_MoCo | 4 | 90.24% | −1.2 | 2.04× |
| This work | 4 | 89.04% | −0.32 | 2.12× |
| (CDG_SimSiam) | | | | |
| FBS_SimSiam | — | 88.21% | −1.15 | 2.00× |
| DGC_SimSiam | 4 | 82.24% | −7.12 | 2.11× |
| CGNet_SimSiam | 4 | 88.65% | −0.71 | 2.03× |

### Sparsity Variation During Contrastive Learning

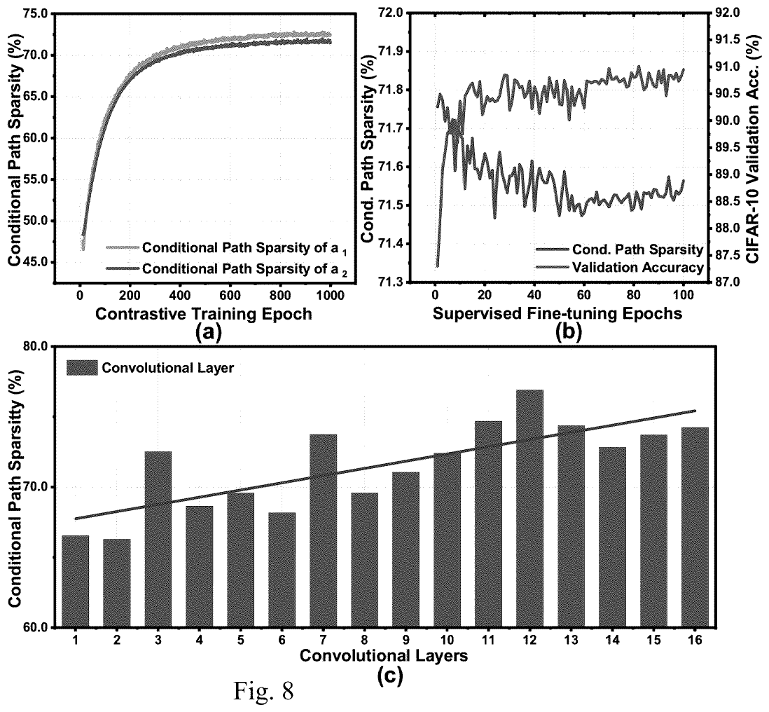

Given the shared regularization target s, the conditional path sparsity between two contrastive branches has minimum difference, as shown in FIG. 8, graph (a). The balanced sparsity exploitation represents successful unbiased training and sparsification. With an inherited base path W_{b}^{a}^{₁} and the learnable threshold τ, the subsequent fine-tuning process optimizes the model with the retained sparsity level, as shown in FIG. 8 graph (b). As shown in FIG. 8 graph (c), the latter layers of the model tend to achieve higher spatial sparsity, since the increase of the channel depth generates more redundant features.

### Sparse Feature Visualization

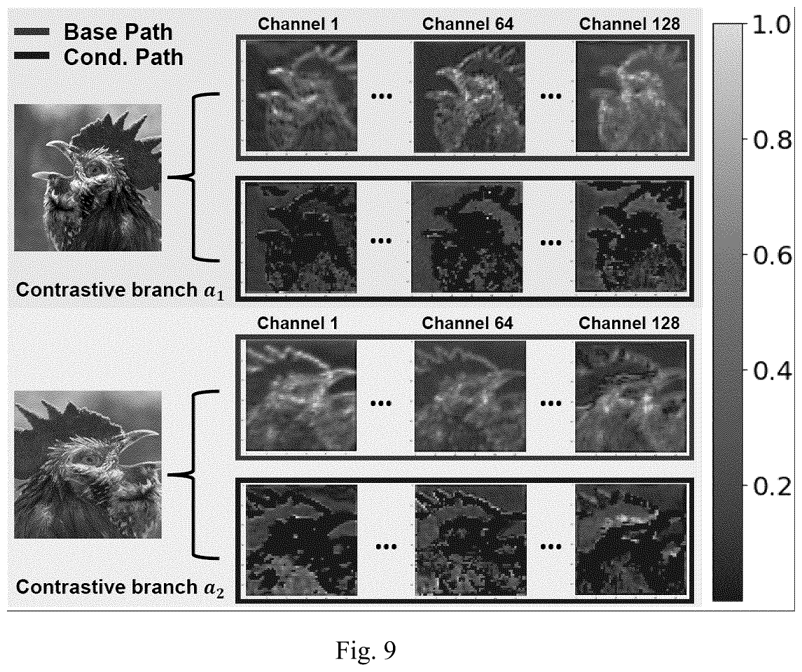

To validate the effectiveness of the proposed CDG algorithm, the experiment visualizes the second convolutional layer of the ResNet-18 (2×) model with ImageNet-100 input. As shown in FIG. 9, for both contrastive branches a₁ and a₂, the base path (red rectangle) preserves the details with the dense computation while the sparse conditional path only keeps the important edges (e.g., the contour of the rooster's crest). As a result, the combined final output saves most of the information with considerable computation reduction.

### Additional Experimental Results with Large Models

The experiment also evaluated the proposed CDG algorithm with the larger ResNet-50 (Chen et al., In International Conference on Machine Learning (ICML), pages 1597-1607, 2020) model. The additional experimental results with the SimCLR (Chen et al., In International Conference on Machine Learning (ICML), pages 1597-1607, 2020) framework on CIFAR- 10, CIFAR-100, and ImageNet-100 datasets are presented below. All experiments were conducted by training the ResNet-50 model from scratch. Following the experimental setup for SimCLR-ResNet-18 (Chen et al., In International Conference on Machine Learning (ICML), pages 1597-1607, 2020), the experiment evaluates the CDG-trained backbone encoder with both linear evaluation protocol and supervised fine-tuning.

### The Impact of Large Encoder

The experiment first demonstrates the performance of the CDG by training the ResNet-50 model with different gating groups and conditional path sparsity on the CIFAR-10 dataset. The increased depth and width of the backbone encoder not only benefits the accuracy but also enhances the model's robustness

With both unstructured (Table 8) and structured (Table 10) sparsity granularity, the ResNet-50 results outperform the ResNet-18 model results in the main Experimental Results section above in terms of both inference accuracy and computation reduction, especially with large numbers of gating groups (e.g., G=4, and G=8). With only 0.75% accuracy degradation, the proposed CDG algorithm achieves 2.40×FLOPs reduction by only using ⅛ dense convolution as the base path computation. With the ResNet-50 model, the proposed CDG algorithm achieves the optimal “sparsity-accuracy” tradeoff when G=8. FIG. 7 shows the CIFAR-10 accuracy and computation reduction with different target s values and conditional path sparsity.

TABLE 8
Accuracy and FLOPs reduction of CDG with ResNet-50 (1×) on
CIFAR-10 dataset with different number of gating groups.

| # of | Conditional | Inference | Top-1 | |
|---|---|---|---|---|
| Gating | Path Sparsity | Accuracy | Accuracy | FLOPs |
| Groups | (%) | (%) | Drop | Reduction |
| 2 | 77.19 | 90.91 | −0.27 | 1.55× |
| 4 | 71.28 | 90.77 | −0.41 | 2.14× |
| 8 | 66.54 | 90.43 | −0.75 | 2.40× |

TABLE 9
Accuracy and FLOPs reduction of CDG on CIFAR-100 and ImageNet-100 datasets
with ResNet-50 (1x)

| | # of Gating | | Conditional Path | Inference | Top-1 Acc. | FLOPs |
|---|---|---|---|---|---|---|
| Model | Groups | Dataset | Sparsity (%) | Acc. (%) | Drop (%) | Reduction |
| ResNet- | 4 | CIFAR-100 | 67.57 | 67.28 | −1.81 | 2.02x |
| 50 (1x) | | ImageNet- | 51.25 | 81.28 | −0.76 | 1.62x |
| | | 100 | | | | |

TABLE 10
Structured contrastive dual gating for different datasets with the spatial group size K =
8 × 1 × 1. After the sparse contrastive pre-training, the model is fine-tuned on 50% of the
training labels.

| | | | Conditional | | | | |
|---|---|---|---|---|---|---|---|
| | # of Gating | | Path Sparsity | Inference | Top-1 | FLOPS | Index |
| Model | Groups | Dataset | (%) | Acc. (%) | Acc. Drop | Reduction | Reduction |
| ResNet- | 4 | CIFAR- | 70.55 | 92.04 | −0.55 | 2.12x | 8x |
| 50 (1x) | | 10 | | | | | |
| | | CIFAR- | 62.24 | 67.44 | −1.65 | 1.87x | 8x |
| | | 100 | | | | | |

On the other hand, the experiment also exploits the sparse features with the ResNet-50 model on the ImageNet-100 dataset, as summarized in Table 9. After the contrastive pre-training, the resulting sparse models are fine-tuned with a 50% labeled training set. Compared to the ResNet-18 (1x) model, ResNet-50 improves the inference accuracy by 4.46% with the cost of 2.34×more computation (FLOPs). The benefits of the large-sized ResNet-50 model (wider and deeper) also improve the CIFAR-100 inference accuracy by 1.24% while maintaining a similar computation reduction.

### Conclusion

A contrastive dual gating (CDG) method is disclosed, a simple and novel dynamic pruning algorithm designed for contrastive self-supervised learning. The disclosed work analyzes different sparse gating strategies with rigorous experiments. Based on the well-knit conclusions, disclosed is a detailed algorithm design to exploit the feature redundancy in both a fine-grained and a structured manner. The proposed algorithms have been verified on multiple benchmark datasets and various SSL frameworks. Without any auxiliary salience predictors, the proposed CDG algorithm achieves up to 2.25×computation reduction for CIFAR-10 dataset, and outperforms other implementations of recent dynamic pruning algorithms. In addition, pruning the model in a structured manner elevates the practicality in terms of efficient hardware computing.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method of training a machine learning algorithm, comprising:
providing a set of input data;
performing first and second transforms on the input data to generate first and second augmented data, to provide first and second transformed base paths into first and second machine learning algorithm encoders;
segmenting the first and second augmented data;
calculating first and second main base path outputs by applying a weighting to the segmented first and second augmented data;
calculating first and second pruning masks from the input and first and second augmented data to apply to the first and second base paths of the first and second machine learning algorithm encoders, the pruning masks having a binary value for each segment in the segmented first and second augmented data, respectively;
calculating first and second sparse conditional path outputs by performing a computation on the segments of the segmented first and second augmented data which are designated with a binary one in the first and second pruning masks, respectively; and
calculating a final output as a sum of the first and second main base path outputs and the first and second sparse conditional path outputs.

2. The method of claim 1, wherein the input data is a set of two-dimensional images.

3. The method of claim 1, wherein the machine learning algorithm is an unlabeled, self-supervised machine learning algorithm.

4. The method of claim 1, wherein the machine learning algorithm does not use a pre-trained dense model.

5. The method of claim 1, wherein the second transform comprises an inverse diagonal transform.

6. The method of claim 1, further comprising eliminating irregular sparse indexes.

7. The method of claim 1, the method not comprising introducing additional feature importance predictors.

8. The method of claim 1, wherein the computation is a sparse computation.

9. The method of claim 1, further comprising applying a conditional weighting to the first and second conditional path outputs.

10. The method of claim 1, wherein the first transform is different from the second transform.

11. The method of claim 10, wherein the first and second transforms comprise color jittering.

12. A computer-implemented system for learning sparse features of a dataset, comprising:
a plurality of input data elements;
first and second transformation modules configured to perform first and second transforms on an input data element selected from the plurality of input data elements, having as an output first and second augmented data;
first and second segmentation modules configured to segment each of the first and second augmented data into informative features and uninformative features;
first and second base paths, configured to apply a base path weight to the uninformative features and provide as an output first and second weighted uninformative features;
first and second masking modules, configured to generate first and second sparse pruning masks from the first and second weighted uninformative features, each sparse pruning mask having a binary value for each segment in the segmented first and second augmented data, respectively;
a first convolution module configured to convolve the first sparse pruning mask, the first informative features, and a conditional weighting, and configured to provide as an output a first sparse feature output;
a second convolution module configured to convolve the second sparse pruning mask, the second informative features, and the conditional weighting, and configured to provide as an output a second sparse feature output; and
first and second output modules configured to add the first and second sparse feature outputs to the first and second uninformative features, configured to provide first and second final outputs.

13. The system of claim 12, wherein the plurality of input data elements are two-dimensional images.

14. The system of claim 12, wherein the first transform is different from the second transform.

15. The system of claim 12, wherein the first or second transform comprises an inverse diagonal transform.

16. The system of claim 12, wherein the first or second transform comprises color jittering.
